(19) United States
(12) Patent Application Publication
(10) Pub. No.: US 2020/0242639 A1
(43) Pub. Date: Jul. 30, 2020

(54) Machine Learning Predictive Driven Actions

(71) Applicant: NCR Corporation, Atlanta, GA (US)

(72) Inventors: Itamar David Laserson, Givat Shmuel (IL); Avishay Farbstein, Bruchin (IL)

(21) Appl. No.: 16/261,214

(22) Filed: Jan. 29, 2019

(51) Int. Cl. G06Q 30/02; G06N 20/00

(52) U.S. Cl. CPC G06Q 30/0202; G06N 20/00

(57) ABSTRACT

A machine-learning algorithm is trained with features relevant to predict a time-series value or rate for a current interval of time. The actual rate is compared against the predicted rate and when a deviation between the actual rate and the predicted rate is outside a threshold deviation, an automated action is processed to attempt to remedy the deviation.

### BACKGROUND

Increasingly enterprises are relying on real-time information and technology to manage operations. The amount of data gathered by enterprises is staggering and access to the data is available at any time and from virtually any location. However, to extract useful information from the data requires further automation and customized programming. As a result, acquiring timely useful information remains an elusive goal for many enterprises.

### SUMMARY

In various embodiments, methods and a system for machine learning predictive driven actions are presented.

According to an embodiment, a method for machine learning predictive driven actions is presented. Specifically, and in one embodiment, a rate is predicted for a current interval of time. An actual rate is calculated for the current interval of time, and a deviation is computed between the rate and the actual rate. Finally, an automated action is processed when the deviation falls outside of a threshold deviation.

### BRIEF DESCRIPTION OF THE DRAWINGS

FIG. 1 is a diagram of a system for machine learning predictive driven actions n, according to an example embodiment.

FIG. 2 is a diagram of a method for machine learning predictive driven actions, according to an example embodiment.

FIG. 3 is a diagram of another method for machine learning predictive driven actions, according to an example embodiment.

FIG. 4 is a diagram of a system for machine learning predictive driven actions, according to an example embodiment.

### DETAILED DESCRIPTION

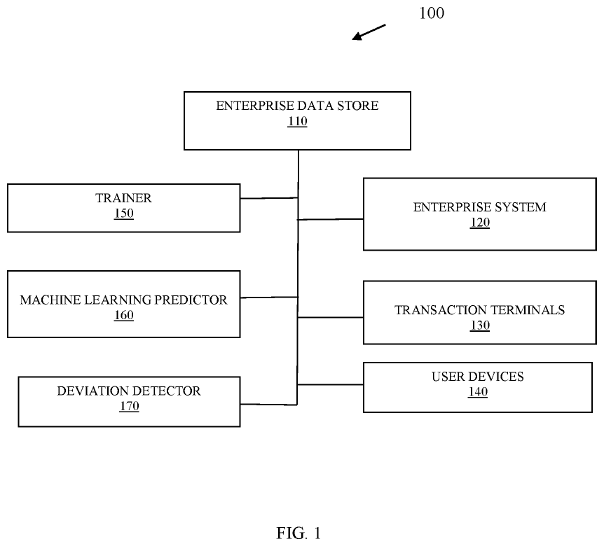

FIG. 1 is a diagram of a system 100 for machine learning predictive driven actions, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of machine learning predictive driven actions presented herein and below.

The system 100 provides an automatic mechanism that provides alerts in real time when a given item's sales rate deviates from their expected rate. The machine-learning predictor 160 is trained on time-series data for purposes of predicting a sales rate of an item for a current time interval. The actual sales rate is computed based on actual sales of the item at a given store location for an enterprise. The predicted sales rate and the actual sales rates are then compared and any deviation (positive or negative) that is greater than a configured threshold causes the deviation detector 170 to send an alert, which drives corrective actions within the enterprise for purposes of achieving the predict sales rate in real time within the enterprise for the given item.

The system 100 includes, an enterprise data store 110, an enterprise system 120, a plurality of transaction terminals 130, user devices 140, a machine-learning trainer 150, a deviation detector 160, and a notifier 170.

The trainer 150, the predictor 160, and the deviation detector 170 are executable instructions that reside in a non-transitory computer-readable storage medium. The executable instructions are executed by one or more hardware processors of computing devices.

The enterprise system 120 and transaction terminals 130 comprise a plurality of hardware devices that execute software as services provided throughout the enterprise over one or more networks (wired, wireless, and/or a combination of wired and wireless.

The enterprise data store 110 captures data gathered throughout the enterprise by the services. One type of data housed in the data store 110 includes transaction data for transactions conducted on the transaction terminals. The transaction data includes sale price, item detail, transaction date, transaction time of day, transaction day of week, store identifiers for stores associated with each transaction, transaction terminal identifiers, and the like. The data store 110 also includes item inventory, item description, item store location, item shelf location within the store, etc. Further, the data store 110 includes a variety of other data such as holiday dates, weather in a particular location on a particular date, sporting event on a given date, any catastrophic newsworthy events observed for a given date.

The enterprise data 110 includes historical transaction data for the enterprise that spans one to several years' worth of transaction data.

The deviation detector 170 includes a user-facing interface that permits a time interval to be custom defined and a specific item identifier for a given item to be selected.

In an embodiment, the time interval is an intraday time interval. In an embodiment, the intraday time interval is three hours.

The deviation detector 170 obtains the historical transaction data using the configured time interval to produce a per item sales pattern for each time interval for a given item over a period of time. The sales pattern represents a time series sales rate for the given item over the period of time. In an embodiment, the period of time is at least one year. In an embodiment, the period of time is three years.

The per item time series data that identifies a given item's sales rates in the given intervals is then provided to the trainer 150 to train the machine-learning predictor 160.

During the training session, the trainer 150 provides as input a variety of features obtained from the time series data (extracted from the data store 110) and provides as an expected output the computed sales rate for each interval.

In an embodiment, the features include:

1. Month of the year.
2. Date of the month.
3. Day of the week.

### 4. Time of the day.

5. Product's price.
6. Proximity to holidays (each holiday represented as separate feature, holidays could include “floating” holidays (holidays that their dates may change over the years, such as Muslim or Jewish holidays); sales patterns of many products change before and during holidays.
7. Weather (including at least: minimal temperature, maximal temperature and precipitations/storm alerts, etc.); sales patterns of many products change in different weather conditions.
8. Sporting events or newsworthy events, a catastrophic event can substantially alter sales patterns for products.
9. Selling rate in adjacent time intervals (for example, the previous time interval or the parallel time interval in the previous day/week/month).
10. Promotions configured on the item (for example, discounts that were known to be provided with the item).

The predictor 160 receives the features as input during the training session with the trainer 150 and for each interval receives the computed sales rate for the item as an expected result. The predictor 160 can be based on any machine-learning algorithm, such as for example linear regression. The predictor 160 configures itself by weighting the various features provided as input and deriving an algorithm, such that when new features are provided to the predictor 160, the predictor 160 produces as a result a predicted sales rate for a given item and a given interval of time.

The trainer 150 iteratively trains the predictor 160 using the time series data computed for each product at the given intervals of time. So, each item (can also be referred to as “product” or “good” herein) can have its own customized predicted sales rate for a given interval based on provided features to the predictor 160. Once the predictor 160 achieves a desired level of accuracy in predicting an item's sales rate for a given interval of time, the predictor 160 is used by the deviation detector 170 to determining when an alert should be raised to one or more of: the enterprise system 120, the transaction terminals 130, and the user devices 140.

The deviation detector 170 receives real-time transaction data from the transaction terminals 130 and computes an actual sales rate for each item being tracked within a given interval or time. The deviation detector 170 also provides the features for the given item as input to the predictor 160. The predictor 160 returns as output the expected sales rate for the item.

The detector 170 compares the actual sales rate for a given item against the predicted sales rate provided by the predictor 160. When a deviation (positive or negative) exceeds or falls below a given threshold deviation (which can be set, changed, and customized using the user-facing interface of the detector 170), the detector 170 issues an alert or takes one or more automated actions.

The alert or automated actions can be sent directly to automated services of the enterprise system 120, the transaction terminals 130, and/or one or more user devices 140. The alert and the automated actions can be configured using the user-facing interface of the detector 170.

For example, an alert may be a text message sent to a phone of a manager or an application (app) message sent to a mobile application that processes on the phone. The alert may also be a message displayed in real time on the transaction terminals 130 during transactions. As another example, the alert is an Application Programming Interface (API) call to a promotion service that automatically discounts a given item or removes an existing discount associated with the given item.

The system trains the predictor 160 using machine learning algorithms to build a sales rate predictor for each product based on configurable time intervals (trained with the features). The predictor's input is the current time interval. The output of the predictor 160 is the expected selling rate of the given product in the given time interval.

The system 100 leverages time series data derived from a sales history of a given product, and, by using the machine learning predictor 160, predicts products' selling rate in real time.

During enterprise hours, the detector 1701 compares the item's actual selling rate to the predicted selling rate and issues alerts and/or performs automated actions in order to bring a given product's sales rate within a configured threshold deviation of the predicted sales rate.

The system 100 is particular useful to store managers who are typically tasked with detecting and resolving sales revenue deviations as quickly as possible to achieve planned revenue. This is an especially difficult task because there are a myriad of factors that can alter store revenues. In some cases and for some products, the manager is expected to manage revenue on an individual product (item) basis and the store can have over 100,000 items. The manager can typically institute a variety of techniques to correct a product's sales but in most instances the manager does not even become aware of an issue until it is too late to adequately correct. Many events can cause a change in a product's sales, such as and by way of example only: 1) the product was out-of-stock on the shelf—it could take a long and valuable amount of time until such cases are detected by the relevant store employee; 2) the location of the product within the store was changed—a product's location on shelves of the store is dynamic and changes are frequent, moving a high revenue product to a different location could cause a significant loss to a retailer, shoppers struggle to find moved products and eventually give up looking, a product may be moved to a different location within the store entirely by mistake and any less suitable location likely results in lost sales for the product; 3) a competitor may have discounts on the product such as when adjacent competing stores attempt to draw customers into their stores with temporary promotions, it is vital for managers to be aware of such situations in a timely manner to avoid loss of customer loyalties with the store; and 4) poor shelf maintenance; for example in a fresh produce department of a store if there are any spoiled products producing a unpleasant odor, customers are deterred from approaching the entire department (appearance can also deter customers, such as dusty wine bottles).

Managers must also be aware of positive deviations in a product sales because such situations if undetected may result in lost opportunities. If a product is selling at a significantly higher rate than planned, the store manager often considers taking some action. For example, moving the product to a better location in the store to increase the sales of the product even further. A manager may also need to increase inventory of the product to prevent the product from running out of stock. Still further, a manager may consider raising the price of the product to maximize revenue. Also, a high selling rate for a product might indicate that a pricing mistake was made and needs corrected to prevent ongoing losses associated with the product.

As can be seen, it is vital that managers be aware of each product's sales rate in order to effectively manage the store revenues. The system 100 provides a real-time mechanism that can be configured to provide real-time alerts and notifications to such managers. The user-facing interface of the detector 170 permits managers to custom-define time intervals to intraday intervals (granular time intervals) and set threshold deviations, such that when a tracked product's sales rate is above or below the threshold deviation set by the manager, an automated alert or automated action is processed. This gives the managers greater control over product sales.

Items' (products) selling rates typically conform to observable patterns. For example, bread products selling rate in the mornings are typically higher than in the evenings. Morning bread sales rate during Monday-Friday would typically be similar. However, weekend morning bread sales would typically be higher than their rate on weekday mornings. Patterns may also change through longer periods, for example sun's screen sales during summer would typically be higher than its sales during the winter. In fact, a newsworthy or sporting event can change product sales rates substantially, during the Super Bowl sales of chicken wings sky rocket.

Accounting for all these factors and the combination of factors is handled through the training of the predictor 160 with the above-referenced features, such that the manager is always aware when product sales are out-of-line with what should be expected when a given set of factors are encountered.

It is to be noted that although examples discussed with the system 100 were directed to managing a given product's sales rate and a given granular interval or time, the system 100 is not so limited and can be used for other alerts and actions relevant to other things, such as inventory management, promotion management, order management, scheduling, and others.

In an embodiment, the trainer 150, the predictor 160, and the detector 170 are provided from a cloud processing environment. In an embodiment, transaction data associated with the enterprise is also maintained in the cloud processing environment.

In an embodiment, the transaction terminals 130 include: a Point-Of-Sale (POS) terminal, a Self-Service Terminal (SST), and/or a kiosk.

In an embodiment, the user devices 140 include: a phone, a tablet, a laptop, and/or a wearable processing device.

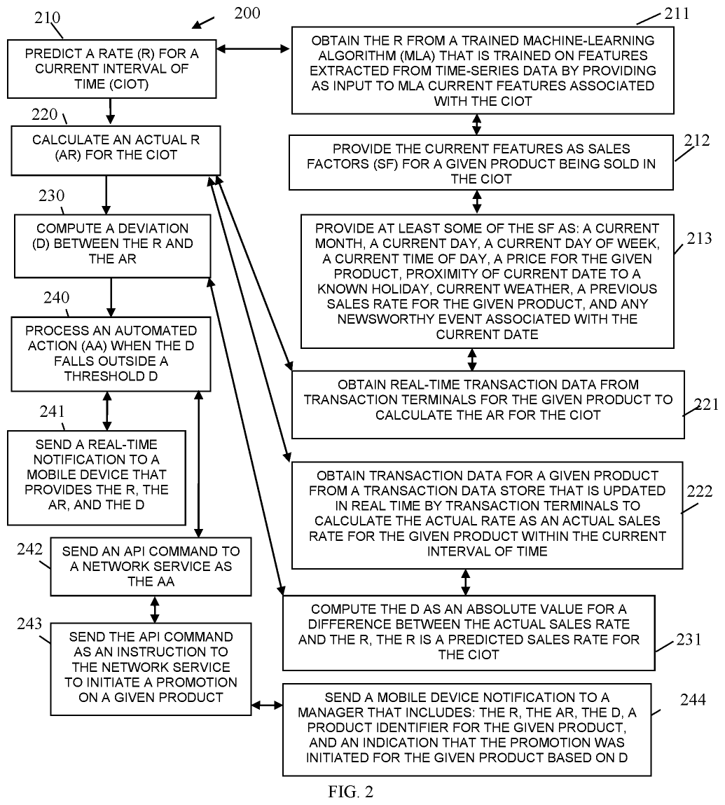

These and other embodiments are now discussed with reference to the FIGS. 2-4.

FIG. 2 is a diagram of a method 200 for machine learning predictive driven actions, according to an example embodiment. The software module(s) that implements the method 200 is referred to as a “predictive action manager.” The predictive action manager is implemented as executable instructions programmed and residing within memory and/or a non-transitory computer-readable (processor-readable) storage medium and executed by one or more processors of a device. The processor(s) of the device that executes the item identifier are specifically configured and programmed to process the predictive action manager. The predictive action manager has access to one or more network connections during its processing. The network connections can be wired, wireless, or a combination of wired and wireless.

In an embodiment, the device that executes the predictive action manager is a server. In an embodiment, the server is a cloud processing environment that comprises multiple servers cooperating with one another as a single server. In an embodiment, the server is a Local Area Network (LAN) server.

In an embodiment, the device that executes the predictive action manager is a network-edge device that is local or on an edge of a LAN of a retail store.

In an embodiment, the predictive action manager is all of or some combination of: the trainer 150, the predictor 160, and/or the deviation detector 170.

At 210, the predictive action manager predicts a rate for a current interval of time.

In an embodiment, at 211, the predictive action manager obtains the rate from a trained-machine learning algorithm that is trained on features extracted for time-series data by providing as input to the trained-machine learning algorithm current features associated with the current interval of time.

In an embodiment of 211 and at 212, the predictive action manager provides the current features as sales factors for a given product being sold at a given store or given location in the current interval of time.

In an embodiment of 212 and at 213, the predictive action manager provides at least some of the sales factors as: a current month, a current day, a current day of week, a current time of day, a price for the given product, proximity of current date to a known holiday, current weather, a previous sales rate for the given product, and any newsworthy even associated with the current date (including sporting events). In an embodiment, the sales factors are the features discussed above with the FIG. 1.

At 220, the predictive action manager calculates an actual rate for the current interval of time.

In an embodiment of 213 and 220, at 221, the predictive action manager obtains real-time transaction data from transaction terminals for the given product to calculate the actual rate for the current interval of time.

In an embodiment, at 222, the predictive action manager obtains transaction data for a given product from a transaction data store that is updated in real time by transaction terminals to calculate the actual rate as an actual sales rate for the given product within the current interval of time.

At 230, the predictive action manager computes a deviation between the rate obtained at 210 and the actual rate obtained at 220.

In an embodiment of 222 and 230, at 231, the predictive action manager computes the deviation as an absolute value for a difference between the actual sales rate and the rate obtained at 210, where the rate obtained at 210 is a predicted sales rate for the current interval of time.

At 240, the predictive action manager processes an automated action when the deviation falls outside a preconfigured threshold deviation.

In an embodiment, at 241, the predictive action manager sends a real-time notification to a mobile device that provides the rate obtained at 210, the actual rate obtained at 220, and the deviation obtained at 230.

In an embodiment, at 242, the predictive action manager sends an API command to a network-based service as the automated action.

In an embodiment of 242 and at 243, the predictive action manager sends the API command as an instruction to the network-based service to initiate a promotion on a given product.

In an embodiment of 243 and at 244, the predictive action manager sends a mobile device notification to a manager's registered device that includes: the rate obtained at 210, the actual rate obtained at 220, the deviation obtained at 230, a product identifier for the given product, and an indication that the promotion was initiated for the given product based on the deviation.

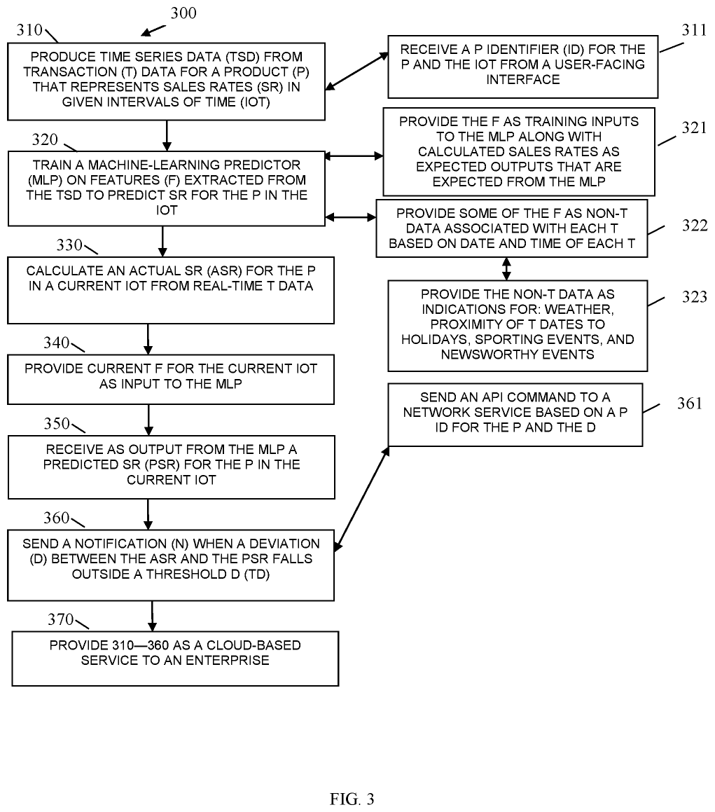

FIG. 3 is a diagram of another method 300 for machine learning predictive driven actions, according to an example embodiment. The software module(s) that implements the method 300 is referred to as an “item sales rate notifier.” The item sales rate notifier is implemented as executable instructions programmed and residing within memory and/or a non-transitory computer-readable (processor-readable) storage medium and executed by one or more processors of a device. The processors that execute the item sales rate notifier are specifically configured and programmed to process the item sales rate notifier. The item sales rate notifier has access to one or more network connections during its processing. The network connections can be wired, wireless, or a combination of wired and wireless.

In an embodiment, the device that executes the item sales rate notifier is a server. In an embodiment, the server is a cloud processing environment that comprises multiple servers cooperating with one another as a single server. In an embodiment, the server is a LAN server that is local to a retail store.

In an embodiment, the device that executes the item sales rate notifier is a network-edge device that is on the edge of a LAN for a retail store.

In an embodiment, the item sales rate notifier is all or some combination of the trainer 150, the predictor 160, the deviation detector 170, and/or the method 200.

The item sales rate notifier presents another and in some ways enhanced processing perspective to that which was described above with the FIG. 2.

At 310, the item sales rate notifier produces or derives time series data from historical transaction data for a product that represents sales rates in given intervals of time for the product within an enterprise or retailer store.

In an embodiment, at 311, the item sales rate notifier receives a product identifier for the product and the given intervals of time from a user-facing interface.

At 320, the item sales rate notifier trains a machine-learning predictor (such as predictor 160) on features extracted from the transaction data store to predict sales rates for the product in the current intervals of time.

In an embodiment, at 321, the item sales rate notifier provides the features as training inputs to the machine-learning predictor along with calculated sales rates as expected outputs that are expected from the machine-learning predictor.

In an embodiment, at 322, the item sales rate notifier provides some of the features as non-transaction data associated with each transaction based on dates and times associated with each transaction within the time-series data.

In an embodiment of 322 and at 323, the item sales rate notifier provides the non-transaction data as indications for: weather, proximity of transaction dates to holidays, sporting events, and newsworthy events.

At 330, the item sales rate notifier calculates an actual sales rate for the product in a current interval of time from real-time transaction data.

At 340, the item sales rate notifier provides current features for the current interval of time and a product identifier for the product to the machine-learning predictor as input to the machine-learning predictor.

At 350, the item sales rate notifier receives as output from the machine-learning predictor a predicted sales rate for the product in the current interval of time.

At 360, the item sales rate notifier sends a notification when a deviation between the actual sales rate and the predicted sales rate falls outside a threshold deviation.

In an embodiment, at 361, the item sales rate notifier sends an API command to a network-based service based on the product identifier for the product and the deviation.

In an embodiment, the item sales rate notifier is provided as a cloud-based service to an enterprise/retailer over a network.

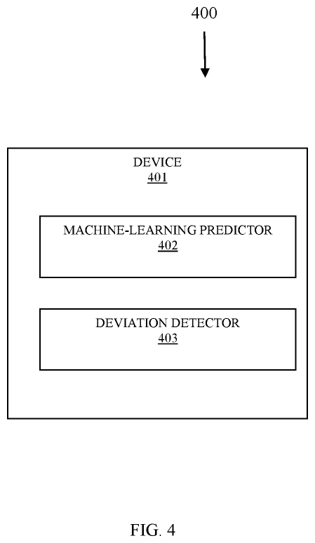

FIG. 4 is a diagram of a system 400 for machine learning predictive driven actions, according to an example embodiment. The system 400 includes a variety of hardware components and software components. The software components of the system 400 are programmed and reside within memory and/or a non-transitory computer-readable medium and execute on one or more processors of the system 400. The system 400 communicates over one or more networks, which can be wired, wireless, or a combination of wired and wireless.

In an embodiment, the system 400 implements, inter alia, the processing described above with the FIGS. 1-3.

The system 400 is the system 100.

The system 400 includes a processing device 401, a machine-learning predictor 402, and a deviation detector 170.

In an embodiment, the processing device 401 is a server. In an embodiment, the server is a collection of servers that cooperate as a cloud processing environment.

In an embodiment, the processing device 401 is a network edge device.

The machine-learning predictor 402 is a set of executable instructions that is executed on one or more hardware processors of the processing device 401 from a non-transitory computer-readable storage medium or memory.

The deviation detector 403 is also a set of executable instructions that is executed on one more hardware processors of the processing device 401 from a non-transitory computer-readable storage medium or memory.

The machine-learning predictor 402, when executed by the processor(s) of the device 401, is configured to: generate and configure an algorithm based on training features and expected results during a training session, and predict a sales rate for a given product during a current interval of time based on current features associated with current sales of the given product.

In an embodiment, the machine-learning predictor 402 is the predictor 160.

The deviation detector 403, when executed by the processor(s) of the device 401, is configured to: compute an actual sales rate for the given product during the current interval of time, provide the current features as input to the machine-learning predictor 402, obtain the sales rate predicted as output from the machine-learning predictor 402, calculate a deviation between the actual sales rate and the sales rate predicted, and perform an automated network-based action when the deviation falls outside a configured threshold deviation.

In an embodiment, the device 401 is a cloud-based device that provides a user-facing interface to a user over a network to configure the machine-learning predictor 402 and the deviation detector 403 for the given product of a given retail store.

It is to be noted that although the various examples presented were within the context of online middleware food service providers, other embodiments of the invention are not so limited, such that any retailer middleware service that sells products other than food can benefit from the teachings presented herein and above.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
predicting a rate for a current interval of time;
calculating an actual rate for the current interval of time;
computing a deviation between the rate and the actual rate; and
processing an automated action when the deviation falls outside of a threshold deviation.

2. The method of claim 1, wherein predicting further includes obtaining the rate from a trained machine-learning algorithm that is trained on features extracted from time-series data by providing as input to the trained machine-learning algorithm current features associated with the current interval of time.

3. The method of claim 2, wherein obtaining further includes providing the current features as sales factors for a given product being sold in the current interval of time.

4. The method of claim 3, wherein providing further includes providing at least some of the sales factors as: a current month, a current day, a current day of a current week, a current time of day, a price for the given product, proximity of current date to a known holiday, current weather, a previous sales rate for the given product in an adjacent interval of time, any promotions associated with the given product, and any newsworthy event associated with the current date.

5. The method of claim 4, wherein calculating further includes obtaining real-time transaction data from transaction terminals for the given product to calculate the actual rate for the current interval of time.

6. The method of claim 1, wherein calculating further includes obtaining transaction data for a given product from a transaction data store that is updated in real time by transaction terminals to calculate the actual rate as an actual sales rate for the given product within the current interval of time.

7. The method of claim 6, wherein obtaining further includes computing the deviation as an absolute value for a difference between the actual sales rate and the rate, wherein the rate is a predicted sales rate for the current interval of time.

8. The method of claim 1, wherein processing further includes sending a real-time notification to a mobile device as the automated action, the real-time notification includes the rate, the actual rate, and the deviation.

9. The method of claim 1, wherein processing further includes sending an Application Programming Interface (API) command to a network service as the automated action.

10. The method of claim 9, wherein sending further includes sending the API command as an instruction to the network service to initiate a promotion on a given product.

11. The method of claim 10 further comprising, sending a mobile device notification to a manager that includes the rate, the actual rate, the deviation, a product identifier for the given product, and an indication that the promotion was initiated for the given product based on the deviation.

12. A method, comprising:
producing time series data from transaction data for a product that shows sales rates for the product in given intervals of time;
training a machine-learning predictor on features extracted from the time series data to predict the sales rates for the product in the given intervals of time;
calculating an actual sales rate for the product in a current interval of time from real-time transaction data;
providing current features for the current interval of time as input to the machine-learning predictor;
receiving as output from the machine-learning predictor a predicted sales rate for the product in the current interval of time; and
sending a notification when a deviation between the actual sales rate and the predicted sales rate falls outside a threshold deviation.

13. The method of claim 12, wherein producing further includes receiving a product identifier for the product and the given intervals of time from a user through a user-facing interface.

14. The method of claim 12, wherein training further includes providing the features as training inputs to the machine-learning predictor along with the calculated sales rates as expected outputs that are expected from the machine-learning predictor.

15. The method of claim 12, wherein training further includes providing some of the features as non-transaction data associated with each transaction based on a date and time of each transaction.

16. The method of claim 15, wherein providing further includes providing the non-transaction data as indications for: weather, proximity of transaction dates to holidays, sporting events, and newsworthy events.

17. The method of claim 12 further comprising, sending an Application Programming Interface (API) call to a network service based on a product identifier associated with the product and the deviation.

18. The method of claim 12 further comprising, providing the method as a cloud-based service to an enterprise.

19. A system, comprising:
a processing device having at least one processor configured to execute instructions from a non-transitory computer-readable storage medium, the instructions representing a machine-learning predictor and a deviation detector;
the machine-learning predictor is configured to: generate and configure an algorithm based on training features and expected results during a training session, and predict a sales rate for a given product during a current interval of time based on current features associated with current sales of the given product; and
the deviation detector is configured to: compute an actual sales rate for the given product during the current interval of time, provide the current features as input to the machine-learning predictor, obtain the sales rate predicted as output from the machine-learning predictor, calculate a deviation between the actual sales rate and the sales rate predicted, and perform an automated network-based action when the deviation falls outside a configured threshold deviation.

20. The system of claim 19, wherein the device is a cloud-based device that provides a user-facing interface to a user over a network to configure the machine-learning predictor and the deviation detector for the given product at a given retail store.
